(19) United States
(12) Patent Application Publication
(10) Pub. No.: US 2012/0048175 A1
(43) Pub. Date: Mar. 1, 2012

(54) BRIDGE DEVICE FOR CONNECTING A FLAG TO A SHACKLE

(76) Inventors: Peter E. Prince, Caledonia, MI (US); Melinda P. Prince, Caledonia, MI (US)

(21) Appl. No.: 13/215,281

(22) Filed: Aug. 23, 2011

Related U.S. Application Data
(60) Provisional application No. 61/377,282, filed on Aug. 26, 2010.

(51) Int. Cl. G09F 17/00; B23P 11/00

(52) U.S. Cl. 116/173; 29/428

(57) ABSTRACT

A flag connection assembly is provided for attaching a flag to a flag pole assembly, where the flag pole assembly includes a flag pole and a halyard, and the flag including at least two openings adjacent a linear edge. A pair of bridge straps are provided, each bridge strap including at least one loop and a loop-remote portion. The halyard includes shackles adapted to snap to the loop-remote portion of the bridge straps. The loops are constructed of flexible material collapsible for pulling through one of the openings, after which it is expandable for pulling the loop-remote portion through the loop to self-attach the bridge straps to the flag. Preferably, the bridge straps are made of a durable woven nylon or cloth and have a length permitting free flapping and movement of the flag in a breeze.

This application claims benefit under 35 U.S.C. section 119(e) of provisional application Ser. No. 61/377,282, filed Aug. 26, 2010, entitled BRIDGE DEVICE FOR CONNECTING A FLAG TO A SHACKLE, the entire contents of which are incorporated herein in its entirety.

### FIELD OF THE INVENTION

The present invention relates to a bridge device for connecting a flag to a shackle.

### BACKGROUND OF THE INVENTION

Flags, such as “stars and stripes” flags raised as a tribute to and symbol of the United States, are connected to and hung from flag poles by various means. However, often the existing connection devices are restrictive, causing the flag to not flow and move freely in a breeze. This can detract greatly from the flag's appearance. Further, many existing attachment arrangements for attaching a flag to a flag pole are cumbersome and difficult to use. Still further, many known attachment arrangements include mechanisms that are not as durable as desired. Also most known attachments create a metal-to-metal contact (such as grommet to shackle contact) that can be unsightly and even destructive as the metal corrodes and wears.

### BRIEF SUMMARY OF THE INVENTION

The present innovation concerns a flag connection assembly for attaching a flag to a flag pole assembly, where the flag pole assembly includes a flag pole and a halyard, the flag including at least two openings adjacent a linear edge and the halyard including shackles. The present innovation includes providing a pair of bridge straps each including at least one loop and a loop-remote portion constructed for attachment to one of the shackles; where each of the loops are constructed of flexible material collapsible for pulling through one of the openings and expandable for pulling the loop-remote portion through the loop to self-attach the bridge straps to the flag. As thus attached, the bridge straps position the loop-remote portions for attachment to the shackles and thus provide a releasable securement to the halyard.

Also in another aspect, an innovative combination includes a flag pole assembly, a flag, and a flag connection assembly for attaching the flag to the flag pole assembly, where the flag pole assembly includes a flag pole and a halyard with at least two shackles; the flag including at least two openings adjacent a linear edge. The flag connection assembly includes a pair of bridge straps each including at least one loop and a loop-remote portion. Each of the loops being constructed of flexible material that is collapsible for pulling through one of the openings and expandable for pulling the loop-remote portion through the loop to self-attach the bridge straps to the flag. Shackles releasably attached to the loop-remote portion.

A method of connecting a flag to a flag pole assembly is provided, where the flag pole assembly includes a flag pole and a halyard with shackles thereon, and where the flag includes at least two openings adjacent a linear edge. The method includes steps of providing a pair of bridge straps each including at least one loop and a loop-remote portion. The bridge straps are constructed of a flexible material. The method includes pulling each bridge strap through one of the openings and expanding the bridge strap so that the loop-remote portion can be pulled through the loop and then pulling the loop-remote portion through the loop, and releasably securing the shackles to the loop-remote portion.

The present innovation also includes a flag connection assembly for attaching a flag to a flag pole assembly, where the flag pole assembly includes a flag pole and a halyard having releasable connectors thereon, and where the flag includes at least two openings adjacent a linear edge. The flag connection assembly includes an elongated flexible member including at least one loop and a loop-remote portion. Each of the loops are constructed of flexible material collapsible for pulling through one of the openings and expandable for pulling the loop-remote portion through the loop to self-attach the flexible member to the flag, with the loop-remote portion including aperture structure for releasable securement to releasable connectors on the halyard.

An object of the present invention is to provide a flag-supporting attachment that eliminates metal-to-metal contact (e.g., of a grommet and a shackle).

### BRIEF DESCRIPTION OF DRAWINGS

FIG. 1 is a side view of a flag pole assembly of the present invention.

FIG. 1A is an enlargement of the circled area IA in FIG. 1.

FIG. 2 is a perspective view of a bridge device of the present invention.

FIG. 3 is a side view of a bridge device of the present invention.

FIG. 4 is a top view of a bridge device of the present invention.

FIG. 5 is a side view of the bridge device in an unassembled configuration illustrating a method of forming the bridge device.

FIG. 6 is a top view of the bridge device in an unassembled configuration illustrating a method of forming the bridge device.

FIG. 7 illustrates steps of a method of connecting the bridge device of the present invention to a flag.

FIG. 8 illustrates a front view of a second embodiment of a connection assembly of the present invention.

### DETAILED DESCRIPTION OF PREFERRED EMBODIMENTS

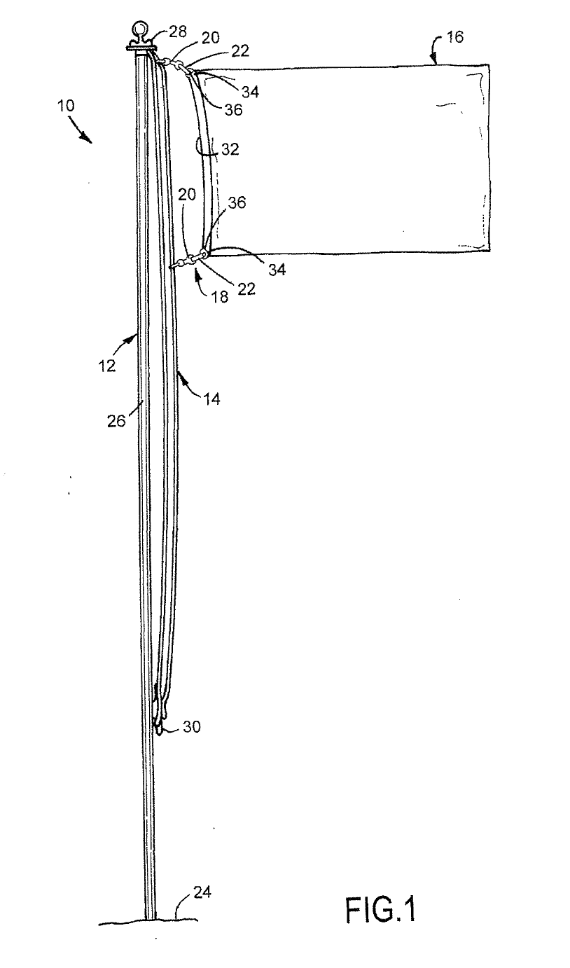

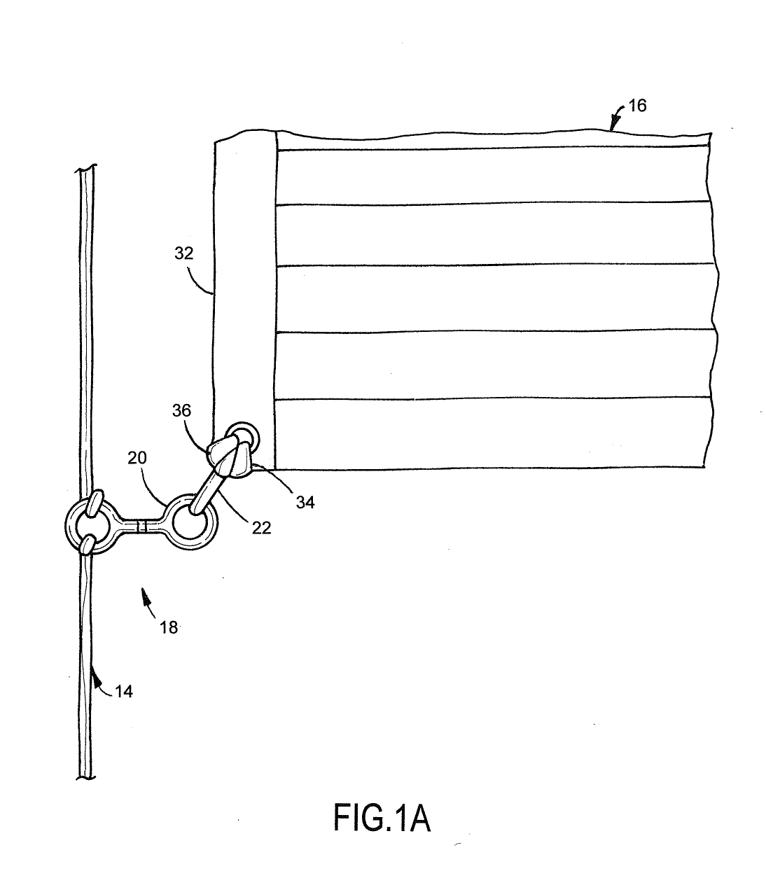

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined herein. Hence, specific dimensions and other physical characteristics relating to the embodiments disclosed herein are not to be considered as limiting, unless expressly stated otherwise.

The reference number 10 (FIG. 1) generally designates a flag pole assembly embodying the present invention. In the illustrated example, the flag pole assembly 10 comprises a flag pole 12, a halyard 14 and a flag 16. A connection assembly 18 connects the flag 16 to the halyard 14. The connection assembly 18 includes a pair of shackles 20 and a pair of bridge devices 22 (also called “bridge straps” herein). Aspects of the present invention include the bridge devices 22, a method of connecting a flag 16 to the bridge devices 22, and a method of making the bridge devices 22.

In the illustrated example, the flag pole 12 is inserted into the ground 24 and is configured to support the flag 16 above the ground 24. The flag pole 12 can comprise any structure for supporting the flag 16 above the ground. In the illustrated example, the flag pole 12 includes a post 26 inserted into the ground and having a truck or pulley 28 at a top thereof. The halyard 14 is connected to the truck or pulley 28 and is configured as an endless loop. The halyard 14 is configured to wind about the truck or pulley 28 to allow the flag 16 to be raised from the ground 24 to the top of the flag pole 12 and lowered back to the ground 24. Such a system with the halyard outside of the post 26 is called an external halyard system. The flag pole 12 can include a cleat 30 at a bottom thereof for typing the halyard thereabout to maintain the flag 16 in the raised position (see FIG. 1). However, it is contemplated that the flag pole 12 could have any configuration. For example, the post 26 could be connected to any stationary (e.g., side of building, roof of building, front of house, etc.) or movable (e.g., boat) object. Moreover, the post 26 could have any cross-sectional configuration (e.g., circular, square, rectangular, octagonal, etc.) The truck or pulley 28 could also have any configuration. Furthermore, the flag pole 12 could have an internal halyard such as that disclosed in U.S. Pat. No. 5,335,621, entitled FLAG SUPPORT SYSTEM, the entire contents of which are hereby incorporated herein by reference. Moreover, the halyard 14 could be formed of common rope, metal cable (e.g., stainless steel cable), polyester or any other material. The flag pole 12 is configured to maintain the flag 16 above the ground 24.

The illustrated flag 16 is connected to the flag pole 12 by the connection assembly 18 and is configured to unfurl in the air. The flag 16 can comprise any shape and have any design thereon. For example, the flag 16 can be rectangular (as shown), triangular, square or any other shape having at least one substantially linear edge 32. The flag 16 includes a pair of spaced openings 34 adjacent the edge 32. Grommets 36 typically surround the openings 34 to strengthen the material of the flag 16 surrounding the openings 34. It is contemplated that the flag could be made of any material (e.g., polyester, cotton or Nylon). The connection assembly 18 connects the flag 16 to the flag pole 12.

In the illustrated example, the connection assembly 18 includes the pair of shackles 20 connected to the halyard 14 and the pair of bridge devices 22 connected to the flag 16. The shackles 20 include a first section connected to the halyard 14 and a second section connected to the bridge device 22. The first section and the second section are preferably rotatable relative to each other. The second section includes an aperture that is selectively opened. It is contemplated that instead of a shackle 20, any clip or other device that can be selectively connected to the bridge device could be used. It is also contemplated that the clip or other device could be permanently connected to the bridge device 22 after the bridge device 22 has been connected to the flag 16.

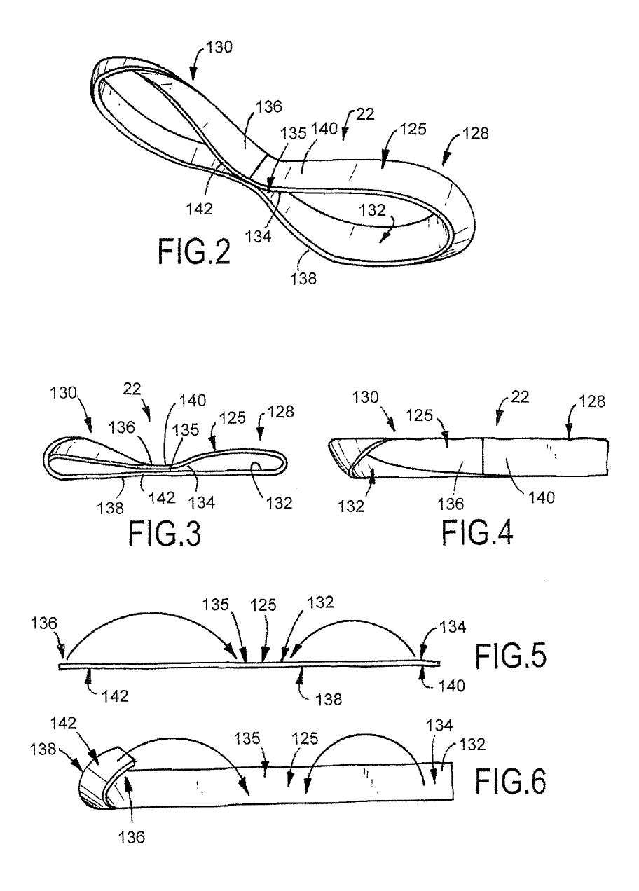

The illustrated bridge devices 22 (see FIGS. 2-4) connect the flag 16 to the shackles 20 or similar devices. The bridge device 22 comprises a substantially flat rectangular piece of material 125 having an untwisted fold forming a first loop 128 and a twisted fold forming a second loop 130. It is contemplated that the material could be any sufficient suitable material. For example, the material could be made of cloth or nylon, such as 9764 ½″ white nylon as sold by Carolina Narrow Fabric Company of Winston-Salem, N.C. The width of the bridge device 22 can be narrower than an internal diameter of the opening 34 in the flag 16 to allow the bridge device 22 to be easily inserted through the opening 34. It is contemplated that a width of the strap making the bridge device 22 could have various cross sectional dimension, and that it's width could be equal to or larger than the diameter of the opening 34. The illustrated material has a cross section size preferably of about ½ inch wide and slightly less than 1/16 inch thick, with the loops each being about 2¼ inch long (for a total length of about 4½ inches), but it is also contemplated that the material could have a thicker section than shown and can be made longer or shorter than shown. For example, the straps could include an elongated flexible strip of material having a width of greater than about ¼ inch and less than about 1 inch.

In the illustrated example, the bridge device 22 can be formed from a flat, rectangular piece of the material 125. The material 125 will have a top side 132 having a first end area 134, a middle area 135 and an opposite second end area 136. Likewise, the material will have a bottom side 138 having a first end area 140 and an opposite second end area 136. The bridge device 22 can be formed by folding the first end area 134 of the top side 132 of the material 125 over onto the middle area 135 of the top side 132 as illustrated in FIGS. 5 and 6 such that the first end area 134 of the top side 132 abuts the middle area 135 of the top side 132. The first end area 134 of the top side 132 is then connected to the middle area 135 of the top side 132. Likewise, the second end area 136 of the top side 132 is twisted and then folded over onto the middle area 135 of the top side 132 as illustrated in FIGS. 5 and 6 such that the second end area 142 of the bottom side 138 abuts the middle area 135 of the top side 132. The second end area 142 of the bottom side 138 is then connected to the middle area 135 of the top side 132. It is contemplated that the first end area 134 of the top side 132 can be connected to the middle area 135 of the top side 132 and the second end area 142 of the bottom side 138 can be connected to the middle area 135 of the top side 132 by adhesive, sewing (e.g., heat) or any other manner.

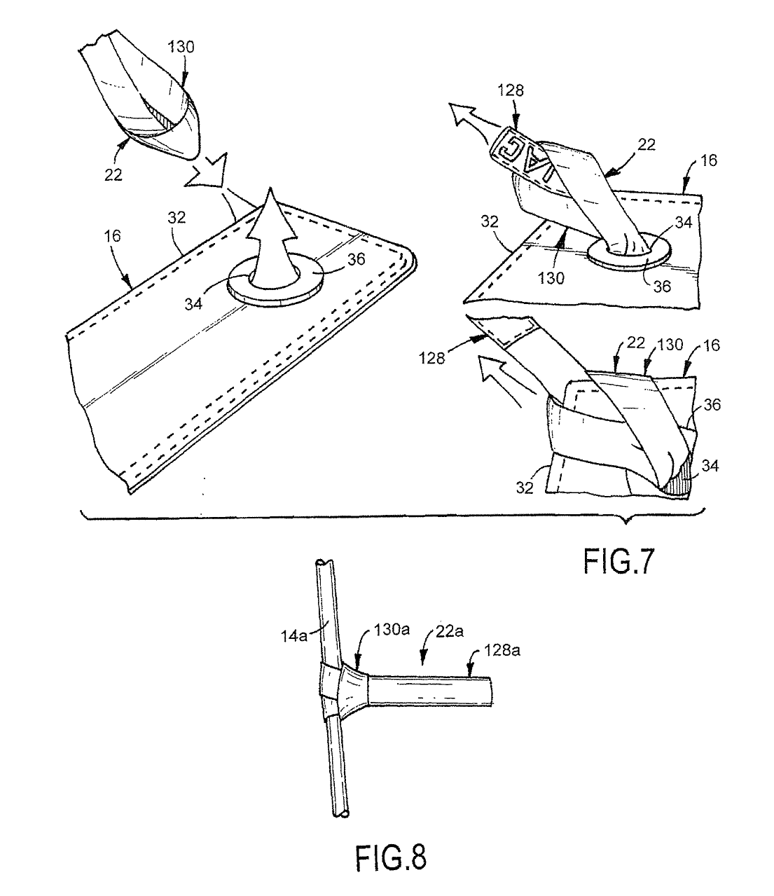

FIG. 7 illustrates the method of connecting the illustrated bridge device 22 to the flag 16. In Step 1 (upper left corner of FIG. 7), the second loop 130 of the bridge device 22 is inserted through the opening 34 in the flag 16. Although the second loop 130 of the bridge device 22 is illustrated as being inserted through the opening 34 from a rear of the flag 16, it is contemplated that the second loop 130 of the bridge device could be inserted through the opening 34 from a front of the flag 16. After the second loop 130 has been inserted through the opening 34 in Step 1, the first loop 128 of the bridge device 22 is inserted through the second loop 130 in Step 2 (see upper right corner of FIG. 7). As shown in Step 3 (lower right corner of FIG. 7), the first loop 128 of the bridge device 22 is pulled away from the flag 16 to securely affix the bridge device 22 to the flag 16. This method of FIG. 7 can be used with all openings 34 in the flag 16. Preferably, the bridge device 22 is employed at least at the openings 34 adjacent a top and a bottom of the edge 32 of the flag 16. As illustrated in Step 3 of FIG. 7, the second loop 130 can include a surface abutting a pair of edges of the flag 16 at a corner of the flag 16. After the bridge devices 22 have been connected to the flag 16, the shackles 20, clip or other device as described above is connected to the bridge device 22 by inserting the shackle 20, clip or other device through the first loop 128 to connect the bridge device 22, and thereby the flag 16, to the shackles 20, clips or other devices, to thereby connect the flag 16 to the halyard 14 and the flag pole 12. For example, the second section of the shackle 20 could include a clip forming a selectively separable circle and the first loop 128 could be inserted into the selectively separable circle while the circle is open, and then the circle can be closed to trap the first loop 128 of the bridge device 22 therein.

The reference numeral 18a (FIG. 8) generally designates another embodiment of the present invention, having a second embodiment for the connection assembly. Since connection assembly 18a is similar to the previously described connection assembly 18, similar parts appearing in FIGS. 1-7 and FIG. 8, respectively, are represented by the same, corresponding reference number, except for the suffix “a” in the numerals of the latter. The second embodiment of the connection assembly 18a includes the bridge device 22a directly connected to the halyard 14a by wrapping the second loop 130a around the halyard 14a and pulling the first loop 128a through the opening in the second loop 130a. The first loop 128a can then be connected to a shackle either permanently or removably connected to the flag (at either at the top of the edge 32 of the flag 16, the bottom of the edge 32 of the flag 16 or both the top and the bottom of the edge 32 of the flag 16). It is also contemplated that the bridge device 18a could be connected to a rope connected to the flag 16 adjacent the edge 32 in a similar manner as shown in FIG. 8 or could be connected to a ring connected to the flag adjacent the edge 32. It is contemplated that the bridge device 22 could be connected to the flag 16 permanently (e.g., by sewing), such that the bridge device 22 includes the first loop 128 extending from a corner of the edge 32 of the flag 16 (similar to that shown in step 2 of FIG. 7). In such a bridge device, the first end area 134 of the bridge device 22 would not have to be folded to form the second loop 130.

The foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. Therefore, it is to be understood that the embodiment shown in the drawings and described above is provided principally for illustrative purposes and should not be used to limit the scope of the invention

The invention claimed is:

1. A flag connection assembly for attaching a flag to a flag pole assembly, the flag pole assembly including a flag pole and a halyard, the flag including at least two openings adjacent a linear edge, the halyard including shackles comprising:
a pair of bridge straps each including at least one loop and a loop-remote portion constructed for attachment to one of the shackles; each of the loops being constructed of flexible material collapsible for pulling through one of the openings and expandable for pulling the loop-remote portion through the loop to self-attach the bridge straps to the flag, thus positioning the loop-remote portion for attachment to the shackles and thus providing a releasable securement to the halyard.

2. The flag connection assembly defined in claim 1, wherein the straps include an elongated flexible strip of material having a width of greater than about ¼ inch and less than about 1 inch.

3. The flag connection assembly defined in claim 2, wherein the straps are made of one of cloth or nylon.

4. The flag connection assembly defined in claim 3, wherein the loop-remote portion comprises another loop, and wherein one of the at least one loop and the another loop include a twisted portion.

5. In combination, a flag pole assembly, a flag, and a flag connection assembly for attaching the flag to the flag pole assembly, an improvement comprising:
the flag pole assembly including a flag pole and a halyard with at least two shackles;
the flag including at least two openings adjacent a linear edge; and
the flag connection assembly including a pair of bridge straps each including at least one loop and a loop-remote portion, each of the loops being constructed of flexible material collapsible for pulling through one of the openings and expandable for pulling the loop-remote portion through the loop to self-attach the bridge straps to the flag, with the shackles releasably attached to the loop-remote portion.

6. The combination defined in claim 5, wherein the straps include an elongated flexible strip of material having a width of greater than about ¼ inch and less than about 1 inch.

7. The combination defined in claim 6, wherein the straps are made of one of cloth or nylon.

8. The combination defined in claim 5, wherein the loop-remote portion comprises another loop, and wherein one of the at least one loop and the another loop includes a twisted portion.

9. A method of connecting a flag to a flag pole assembly, where the flag pole assembly includes a flag pole and a halyard with shackles thereon, and where the flag includes at least two openings adjacent a linear edge, comprising steps of:
providing a pair of bridge straps each including at least one loop and a loop-remote portion; the bridge straps being constructed of a flexible material;
pulling each bridge strap through one of the openings and expanding the bridge strap so that the loop-remote portion can be pulled through the loop; and then pulling the loop-remote portion through the loop; and
releasably securing the shackles to the loop-remote portion.

10. A flag connection assembly for attaching a flag to a flag pole assembly, the flag pole assembly including a flag pole and a halyard having releasable connectors thereon, the flag including at least two openings adjacent a linear edge, comprising:
an elongated flexible member including at least one loop and a loop-remote portion, each of the loops being constructed of flexible material collapsible for pulling through one of the openings and expandable for pulling the loop-remote portion through the loop to self-attach the flexible member to the flag, with the loop-remote portion including aperture structure for releasable securement to releasable connectors on the halyard.

11. The flag connection assembly defined in claim 10, wherein the flexible members include an elongated flexible strip of material having a width of greater than about ¼ inch and less than about 1 inch.

12. The flag connection assembly defined in claim 11, wherein the flexible members are made of one of cloth or nylon.

13. The flag connection assembly defined in claim 11, wherein the loop-remote portion comprises another loop, and wherein one of the at least one loop and the another loop includes a twisted portion.
